(19) United States
(12) Patent Application Publication
(10) Pub. No.: US 2007/0152519 A1
(43) Pub. Date: Jul. 5, 2007

(54) Blade and yoke arrangement for cooling stator windings

(75) Inventors: Yousef Jarrah, Tucson, AZ (US); Jonn Herzberger, Tempe, AZ (US); Desi Riedel, Phoenix, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Tokyo (JP)

(21) Appl. No.: 11/638,834

(22) Filed: Dec. 13, 2006

Related U.S. Application Data
(60) Provisional application No. 60/755,746, filed on Dec. 29, 2005.

(51) Int. Cl. H02K 9/06; H02K 9/00; H02K 7/00; F04B 17/00

(52) U.S. Cl. 310/58; 310/62; 310/67 R; 417/354; 417/423.8

(57) ABSTRACT

A fan comprises a hub and a stator coil disposed with the hub. A first set of blades is disposed about the hub. Second blades are disposed on an interior of the hub. An opening is provided through the face of the hub. When the fan is operating, a flow of air passes through the opening which is then captured by the second blades and redirected across the stator coils to provide cooling.

### CROSS-REFERENCES TO RELATED APPLICATIONS

The present application claims priority from U.S. Provisional Application Ser. No. 60/755,746, filed Dec. 29, 2005, and is fully incorporated herein by reference for all purposes.

### BACKGROUND OF THE INVENTION

The present invention relates generally to cooling fans, and in particular to a fan configured to cool the stator windings of a motor component of the cooling fan.

FIG. 7 shows an exploded cross-sectional view of components comprising a conventional cooling fan. The figure shows a base 702 that is part of the cooling fan housing (not shown) onto which a stator is mounted. Typically, the base 702 includes a small printed circuit board for the electronics which control motor operation. Power and control wires (not shown) run from the printed circuit board for connection to an external power source and to a computer. The stator assembly comprises a coil subassembly 704 comprising some number of individually activated coils wound about a bearing liner 706. A rotor assembly is positioned around the stator coil 704. The rotor assembly includes a yoke 708 which is shaped like a cup that fits around the stator coil 704. An axle 710 is axially connected to the interior of the yoke 708. A number of permanent magnets 712 are fixedly mounted about the interior periphery of the yoke 708. When the yoke 708 is assembled with the stator assembly, the axle 708 is received within the bearing liner 706 and the permanent magnets 712 are disposed around the coil subassembly 704. The axle 710 rests on a bearing surface neat the bottom of the bearing liner 706. An impeller 714, comprising a hub 716 and some number of fan blades 718 attached to the hub, fits over the yoke 708 and is connected to the yoke.

Rotation of the rotor assembly results in suitably timed activation and deactivation of the coils in the coil subassembly 704. The fan blades 718 are typically configured so that the resulting flow of air is toward the rotor assembly (inlet airflow) and away from the stator assembly (outlet airflow).

The motor essentially comprises the coil subassembly 704 and the permanent magnets 712. Due to the constant flow of current in the stator windings of the motor, the stator windings of a cooling fan motor can get quite hot.

### BRIEF SUMMARY OF THE INVENTION

Embodiments of the present invention include secondary blades disposed in the interior of the hub of a fan, in addition to the primary blades of the fan. The secondary blades blow air through openings provided in the yoke of the stator. The air flow through the stator provides significant cooling of the stator windings, thus allowing for the motor to run at higher speeds and higher torque levels. The secondary blades can be configured to achieve desired levels of cooling. Lab results have shown substantial temperature reductions, ranging from 5° C. to 40° C.

### BRIEF DESCRIPTION OF THE DRAWINGS

FIGS. 1 and 2 show an embodiment of an impeller according to the present invention.

FIG. 3 illustrates a schematic cross-sectional view of a hub embodiment according to the present invention.

FIG. 4 illustrates a schematic cross-sectional view of a fan assembly embodied according to the present invention.

FIG. 5 is perspective view of a fan embodied in accordance with the present invention, showing openings formed in the yoke of the fan.

FIGS. 6A-6E illustrate various configurations of openings in a yoke in accordance with the present invention.

FIG. 7 shows an exploded view of components comprising a conventional cooling fan.

### DETAILED DESCRIPTION OF THE INVENTION

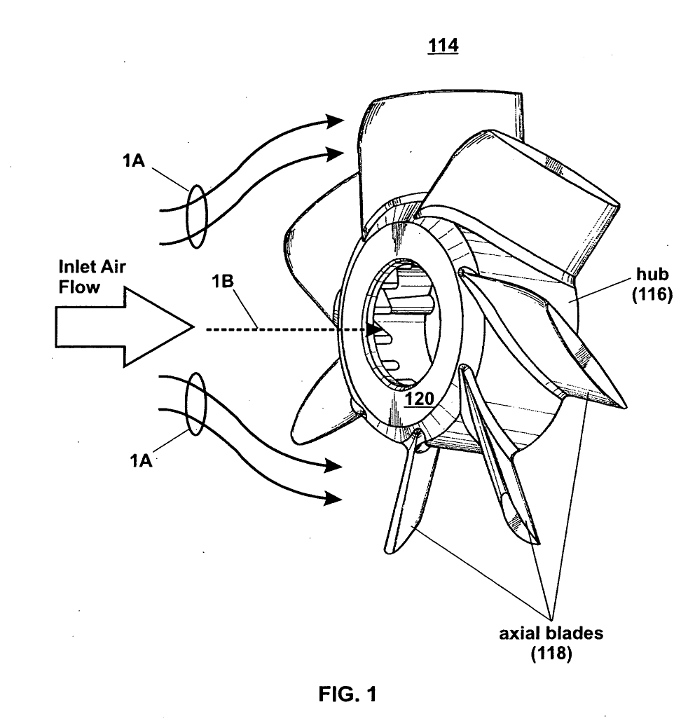

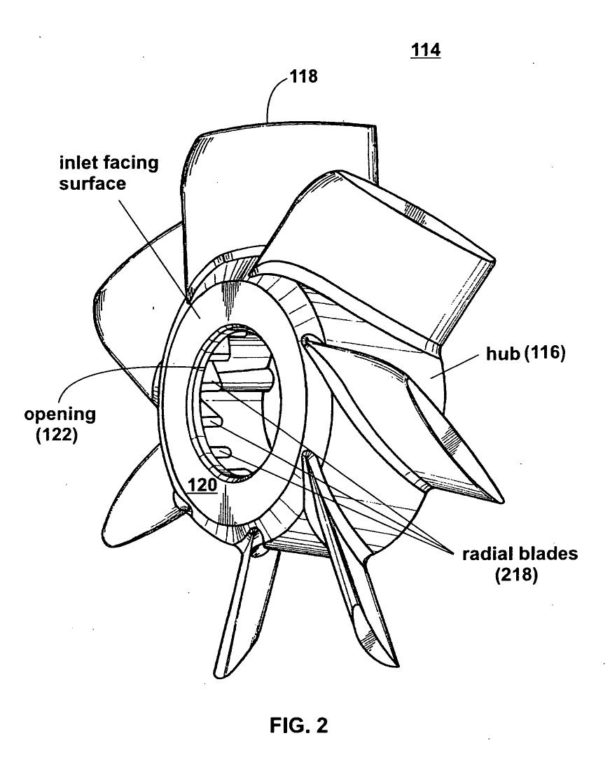

FIGS. 1 and 2 illustrate the basic components of an impeller 114 according to an illustrative embodiment of the present invention. The impeller 114 comprises a hub 116 to which fan blades 118 are attached. For purposes of identification, these blades 118 are referred to as primary blades. The direction of inlet air flow is toward an inlet facing surface 120 of the hub 116 when the impeller 114 is operated. The primary blades 118 are configured to capture a portion of the inlet air flow to create a primary flow 1A in the axial direction, which flows around the hub 116. Consequently, the primary blades 118 can also be referred to as axial blades.

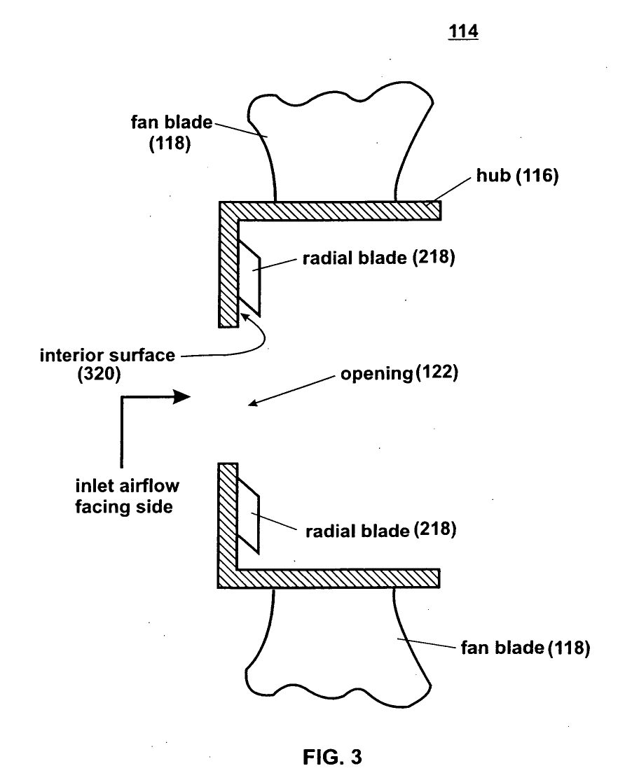

Referring to FIGS. 1-3, an opening 122 is provided through the inlet facing surface of the hub 116. As a result of having a hub opening 122, a secondary flow component 1B of the inlet air flow is created. The interior of the hub 116 includes a set of secondary blades 218. In this particular illustrative embodiment of the present invention, the secondary blades 218 are disposed about an interior surface 320 opposite the inlet facing surface 120. As will be explained in more detail, the secondary flow 1B is captured by the secondary blades 218 and is radially distributed in the volume of space in the interior of the hub 116. For this reason, the secondary blades 218 can also be referred to as radial blades. The secondary blades 218 depicted in the figures are schematic in nature. The actual shape of the secondary blades 218, their size, numbers, and so on can be optimized for specific dimensions of the fan components. In addition, any suitable material can be used for the secondary blades 218 and can be the same or different material as used to make the primary blades 118.

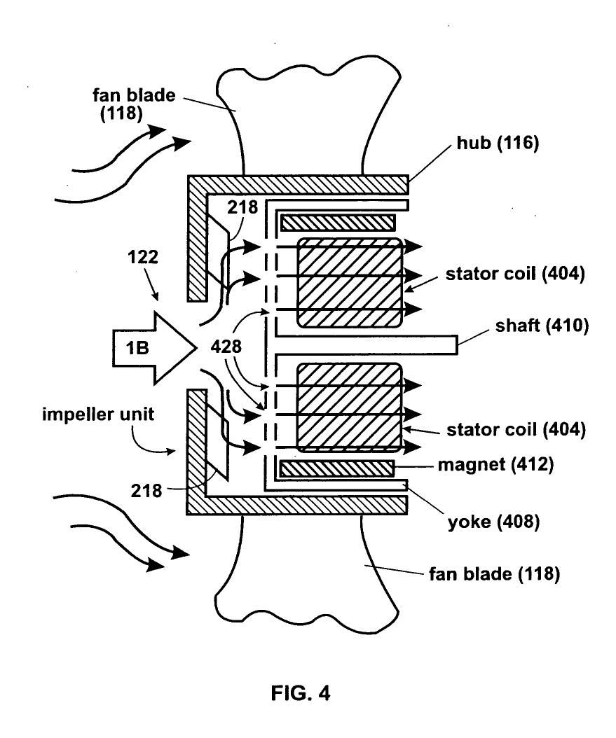

FIG. 4 shows an assembly in accordance with an illustrative embodiment of the present invention, comprising the impeller 114 and a motor sub-assembly. Though the illustrated embodiment shows a brushless DC motor, it will be appreciated that other motor configurations can be used. The motor sub-assembly comprises a rotor component comprising a yoke 408 and an annular-shaped magnet 412 that is fixedly disposed in an interior of the yoke. The motor sub-assembly further comprises a stator component comprising stator coils 404 which are maintained in a fixed position. Typically the stator coils 404 are affixed to a portion of the housing of the fan.

The rotor component is fixed within the interior volume of the hub 116 of the impeller 114. This assemblage of impeller and rotor component can be referred to variously as the fan rotor, rotor assembly, or simply the rotor. The yoke 408 includes a shaft 410 (or axle) which rotatably supports the fan rotor assembly. The shaft 410 serves as an axis of rotation about which the rotor assembly rotates during operation of the fan.

As mentioned above, the resulting air flow during fan operation includes a secondary flow component 1B through opening 122. As can be seen in FIG. 4, the secondary blades 218 rotate as the hub 116 spins during operation of the fan. The secondary flow 1B is captured by the rotating secondary blades 218 and is radially directed into the interior volume of the hub 116. Openings 428 formed in the yoke 408 permit the radially directed air flow (indicated the by the arrows) to pass into the interior volume of the yoke within which is contained the stator coils 404. The resulting flow of air across the stator coils 404 carries away heat produced by the current flowing through the coils during fan operation. So long as the fan is operating, the secondary blades 218 will continue to capture a portion of the inlet airflow and direct through the openings in the yoke 408 to provide a continuous cooling effect.

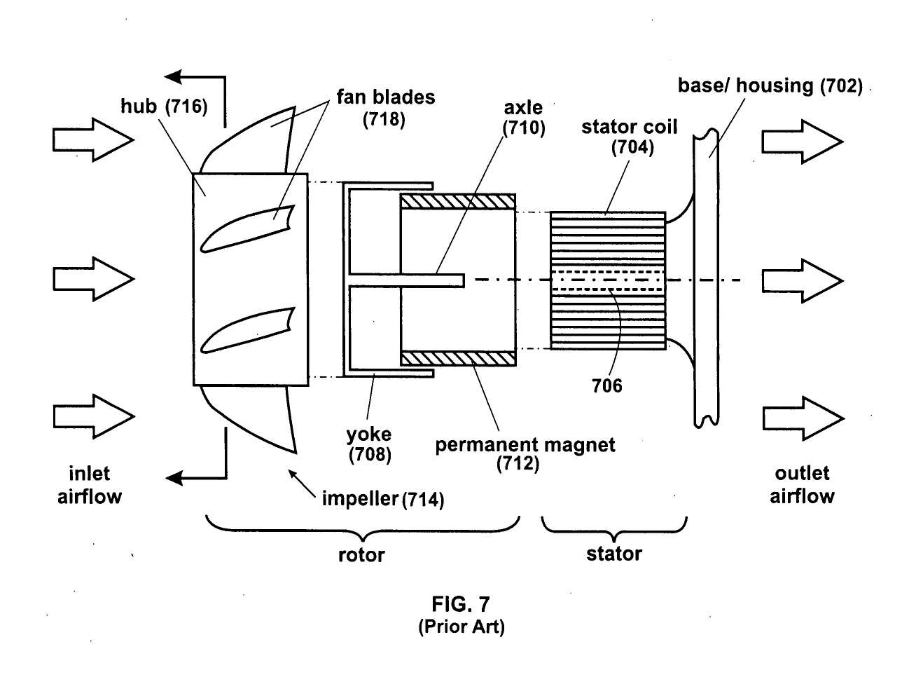

Although the stator coils are a main source of heat, it is noted that the printed circuit board that is usually provided at the base of the fan (e.g., 702, FIG. 7) typically include heat generating electronic components. It will be appreciated that the flow of air passing across the stator coils will also pass over and around the printed circuit board, and thus carry away some of the heat generated by the printed circuit board. Generally, the heat that accumulates within the yoke 408, regardless of its sources, will be carried away in large part by the airflow created by the secondary blades 218 of the present invention.

Conventional cooling techniques simply provide an opening in the hub and openings in the yoke. Air flow across the stator coils results from the flow created by the primary blades. However, the flow created by the primary blades is directed largely across the primary blades. The flow component through the hub and yoke openings is relatively minor. By comparison, the secondary blades provided according to the present invention create a significantly greater flow of air across the stator coils and thus significantly increases the cooling effect. Consequently, the motor can be run at higher speeds and higher torque levels since the additional heat created by the increase in current through the coils can be dissipated.

It might be desirable to vary the amount of cooling effect that the secondary blades 218 provide. For example, hotter running fan motors of course would require more cooling, while cooler fan motor applications may require lesser cooling. The amount of cooling is varied by varying the amount of airflow across the motor and electronics. A primary design parameters include blade camber angle, blade stagger angle, blade chord, and number of blades.

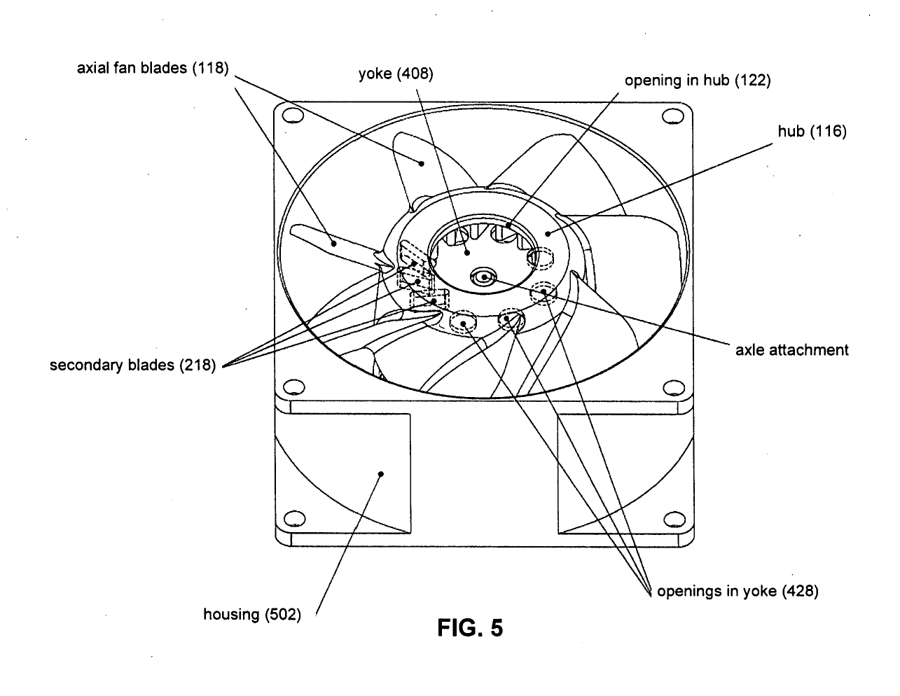

An example of a fan constructed according to the present invention is shown in FIG. 5. This type of fan is typically found in computer equipment such as desktop personal computers, network switching equipment, and so on, and other electronic equipment such as copying machines, overhead projection devices, and such. It can be appreciated that most fans can be adapted according to the present invention can be readily adapted for use generally with electronic devices where adequate heat dissipation is important.

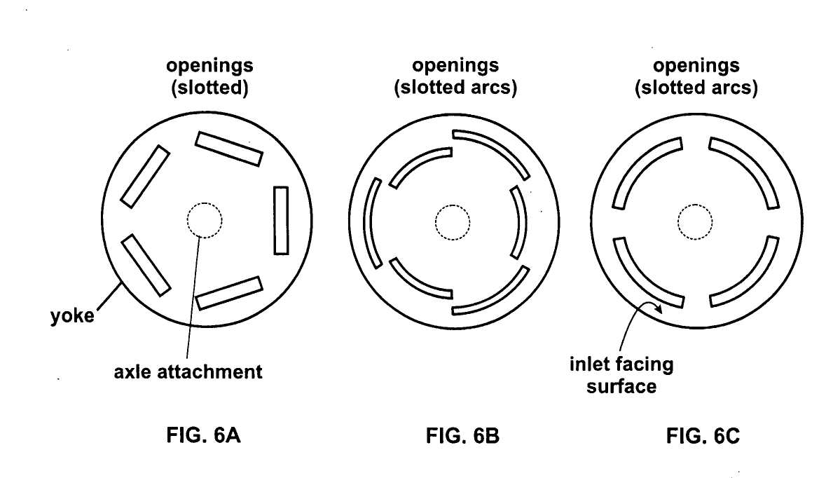

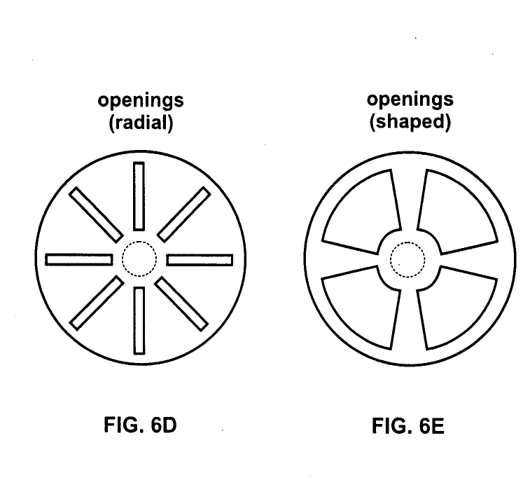

Referring now to FIG. 5, a housing 502 serves to contain the components of the fan. Though not shown the stator coils 404 shown in FIG. 4 are typically mounted to the struts extending from the housing, which in FIG. 5 would be found at the bottom of the housing 502. The hub 116 (and its fan blades 118) fit within the housing 502. FIG. 5 shows the opening 122 formed through the inlet facing surface of the hub 116. A portion of the yoke 408 is shown exposed through the opening 122. Shown in dashed lines are openings 428 formed through the yoke 408 to provide a path for the flow of air into the interior of the yoke. FIG. 5 shows the openings 428 in the yoke 408 to be circular in shape. However, it should be appreciated that other shaped openings are possible, as illustrated in FIGS. 6A-6E, for example. Some of the secondary blades 218 are illustrated (see dashed lines) disposed about the interior of hub 116 in accordance with the present invention.

FIGS. 6A-6E show various top-view configurations of openings in the yoke. The figure is a top view looking down at the inlet facing surface of the yoke. In addition to circular-shaped openings as shown in FIG. 5, the openings can be slotted openings (FIG. 6A). The slots can overlap as shown in FIG. 6B. The openings can be arcuate slots (FIG. 6C), rectangular slots (FIGS. 6A and 6D), and so on. FIG. 6D shows radially-directed openings in the yoke. For example, slots may be arranged in a radial manner relative to the center of the yoke. Openings can be large openings such as the pie-shaped openings shown in FIG. 6E. 1241 It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A fan motor unit comprising a hub having a plurality of fan blades disposed thereabout, a yoke for supporting a magnetic component, the yoke being fixedly disposed within the hub, a stator disposed within the interior of the yoke, a plurality of secondary fan blades disposed on an interior surface of the hub, an inlet facing side of the yoke having plural openings therethrough, and an inlet facing side of the hub having at least one opening therethrough for receiving an axial inflow of air, the yoke being axially supported for rotation about an axis of rotation.

2. The fan of claim 1 wherein the openings in the yoke comprise hole-shaped openings.

3. The fan of claim 1 wherein the openings in the yoke comprise slotted openings.

4. The fan of claim 1 wherein the openings in the yoke comprise overlapping slotted openings.

5. The fan of claim 1 wherein the openings in the yoke comprise radially oriented openings.

6. A fan motor unit comprising a hub to which primary fan blades are attached, an inlet facing side of the hub having an opening therethrough, and secondary fan blades disposed on an interior surface of the hub, wherein an axial inflow of air is produced by rotation of the primary fan blades, wherein a portion of the axial inflow of air passes through the opening and is captured by the secondary blades, wherein the secondary fan blades are radial blades.

7. A fan motor unit comprising a hub to which primary fan blades are attached, an inlet facing side of the hub having one or more openings therethrough, secondary fan blades disposed on an interior surface of the hub, and a yoke axially aligned with an axis of rotation of the hub, the yoke disposed within the hub, the yoke having openings on a top surface thereof,
wherein an axial inflow of air is produced by rotation of the primary fan blades, wherein a portion of the axial inflow of air passes through the one or more openings of the hub, wherein the secondary fan blades redirect at least some of the axial inflow of air through the openings of the yoke.

8. A fan assembly comprising:
a drive device;
a hub member coupled to the drive device, the hub member provided in an axial orientation;
a plurality of main blade members operably coupled to the hub member, the plurality of main blade members being adapted to capture flow at an inlet and to output the captured flow at an outlet;
an open region provided on a front face region of the hub member; and
a plurality of secondary blades spatially disposed around a periphery of the open region, the plurality of the secondary blades being configured to capture flow through the open region on the front face region and to output the flow in a centrifuged manner to a portion of the drive device to cause thermal energy to be removed.

9. The assembly of claim 8 wherein the portion of the drive device comprises a stator coil.

10. The assembly of claim 8 wherein the front face region is a front face of the hub member.

11. The assembly of 8 wherein the front face region is normal to the axial orientation.

12. A fan assembly comprising:
a motor comprising a yoke and stator coil disposed within the yoke, the yoke being rotatably supported for rotation about an axis passing through the stator, the yoke having openings therethrough to expose portions of the stator coil; and
a hub fixedly disposed about the yoke, the hub having first means for creating an axial airflow component, the hub having second means for capturing a portion of the axial airflow and directing the captured portion of the axial airflow to the openings in the yoke thereby providing a flow of air across the stator coils.

13. The fan assembly of claim 12 wherein the first means comprise fan blades disposed about the hub.

14. The fan assembly of claim 12 wherein the hub includes an opening through an inlet surface thereof that faces the axial airflow component, wherein the second means comprises blades disposed on a surface opposite the inlet surface.
